(19) United States
(12) Patent Application Publication
(10) Pub. No.: US 2026/0259582 A1
(43) Pub. Date: Sep. 3, 2026

(54) PROTECTIVE FILM AND ELECTRONIC APPARATUS

(71) Applicant: Samsung Display Co., Ltd., Yongin-si (KR)

(72) Inventor: Jonghwan CHO, Yongin-si (KR)

(73) Assignee: Samsung Display Co., Ltd., Yongin-si (KR)

(21) Appl. No.: 19/552,720

(22) Filed: Feb. 27, 2026

(30) Foreign Application Priority Data
Feb. 28, 2025 (KR) 10-2025-0027017
May 16, 2025 (KR) 10-2025-0063675

(51) Int. Cl. G06F 1/16; G02B 1/111; G02B 1/14

(52) U.S. Cl. CPC G06F 1/1656; G02B 1/111; G02B 1/14; G06F 1/1641

(57) ABSTRACT

Provided are a protective film and an electronic apparatus, wherein the protective film includes a base layer, a hard coating layer on the base layer, and an anti-reflection layer on the hard coating layer, and the anti-reflection layer includes a silsesquioxane cage polymer formed from components including a fluorine-based silsesquioxane and an acrylate-based monomer, thereby providing excellent durability as well as providing low reflection characteristics.

### CROSS-REFERENCE TO RELATED APPLICATIONS

This application claims priority under 35 U.S.C. § 119 of Korean Patent Application Nos. 10-2025-0027017, filed on Feb. 28, 2025, and 10-2025-0063675, filed on May 16, 2025, the entire contents of which are hereby incorporated by reference.

### BACKGROUND

The present disclosure relates to a protective film and an electronic apparatus, and more particularly, to a protective film and an electronic apparatus including the same.

Various electronic apparatuses, such as a television, a mobile phone, a tablet computer, and a game console, are being developed. Recently, flexible electronic apparatuses including flexible display panels capable of folding, rolling, or sliding are being developed. The flexible electronic apparatus may be deformable in various ways, such as foldable, rollable, or, bendable, and may thus be portable regardless of the size of a display screen. The flexible electronic apparatus requires members for maintaining reliability in flexible operation.

### SUMMARY

The present disclosure provides a protective film having excellent low-reflection characteristics and durability.

The present disclosure also provides an electronic apparatus with excellent folding reliability and improved display quality.

An embodiment of the present disclosure provides a protective film including a base layer, a hard coating layer on the base layer, and an anti-reflection layer on the hard coating layer, wherein the anti-reflection layer includes a silsesquioxane cage polymer, and the silsesquioxane cage polymer is formed from components including a fluorine-based silsesquioxane and an acrylate-based monomer.

In an embodiment, the fluorine-based silsesquioxane may include at least one perfluoroalkyl group represented by Formula A.

—CₙF₂ₙ₊₁ [Formula A]

In Formula A above, n may be an integer of 4 or greater and 30 or less.

In an embodiment, the perfluoroalkyl group may be connected to a silicon atom of the fluorine-based silsesquioxane via an ethylene group as a linker.

In an embodiment, the fluorine-based silsesquioxane may be represented by Formula 1.

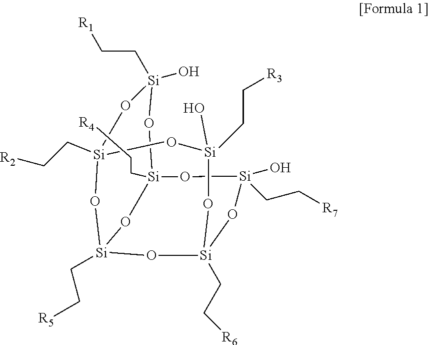

In Formula 1 above, R₁ to R₇ may be each independently —CₙF₂ₙ₊₁, and n may be an integer of 4 or greater and 30 or less.

In an embodiment, the fluorine-based silsesquioxane may be represented by Formula 1-1 below.

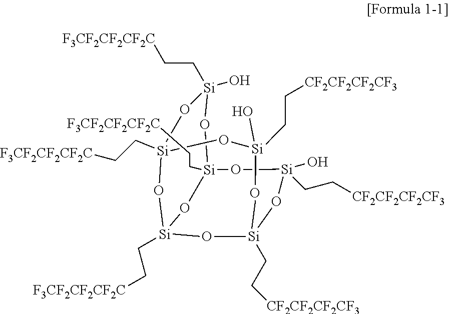

In an embodiment, the acrylate-based monomer may include at least one of trimethylolpropane trimethacrylate or cyclohexyl methacrylate.

In an embodiment, the silsesquioxane cage polymer may be formed from Formula 3 below.

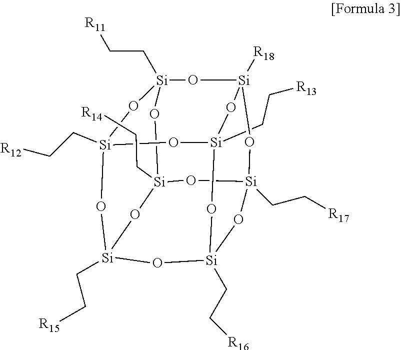

In Formula 3 above, R₁₁ to R₁₇ may be each independently —CₘF₂ₘ₊₁, R₁₈ may be represented by Formula B1 or Formula B2 below, and n may be 4 or greater and 30 or less.

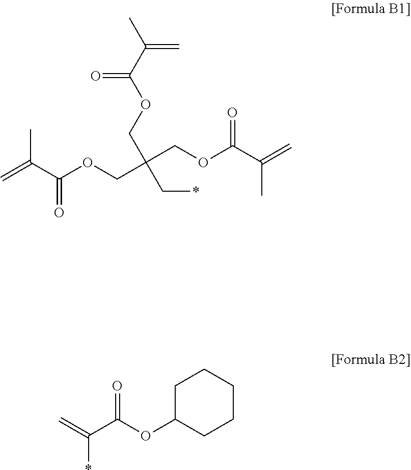

In an embodiment, in Formula 3 above, R₁₁ to R₁₇ may be —CF₂CF₂CF₂CF₃.

In an embodiment, in Formula 3 above, R₁₁ to R₁₇ may be all the same.

In an embodiment, the silsesquioxane cage polymer may include at least one among compounds in Compound Group 1.

In an embodiment, the anti-reflection layer may be a single layer.

In an embodiment, the anti-reflection layer may have a specular component included (SCI) reflectance of about 1.5% or less for light with a wavelength of about 550 nm (the term “about” means ±5% for purposes of this specification).

In an embodiment, the anti-reflection layer may have a water contact angle of about 95° or greater.

In an embodiment, the anti-reflection layer may have a thickness of about 95 nm or greater and about 105 nm or less.

In an embodiment, the silsesquioxane cage polymer may be formed from components including the fluorine-based silsesquioxane in an amount of about 35 wt % or greater and about 60 wt % or less and the acrylate-based monomer in an amount of about 40 wt % or greater and about 65 wt % or less on the basis of a total 100 wt % of the fluorine-based silsesquioxane and the acrylate-based monomer.

In an embodiment, the anti-reflection layer may be formed by a vacuum deposition polymerization method.

In an embodiment of the present disclosure, an electronic apparatus includes a display module in which at least one folding part and non-folding parts, spaced apart from each other with the at least one folding part therebetween, are defined along one direction, and a window module on the display module and including a window and a protective film stacked in sequence, the protective film includes a base layer, a hard coating layer on the base layer, and an anti-reflection layer on the hard coating layer, the anti-reflection layer includes a silsesquioxane cage polymer, and the silsesquioxane cage polymer is formed from components including a fluorine-based silsesquioxane and an acrylate-based monomer.

In an embodiment, a first non-folding part, a first folding part, a second non-folding part, a second folding part, and a third non-folding part may be defined along the one direction in the display module.

In an embodiment, the silsesquioxane cage polymer may have a Ts cage structure.

In an embodiment, the silsesquioxane cage polymer may include 8 silicon atoms in a molecule, and a perfluoroalkyl group represented by Formula A may be connected to 7 silicon atoms among the 8 silicon atoms, and trimethylolpropane trimethacrylate or cyclohexyl methacrylate may be connected to a remaining one silicon atom.

### BRIEF DESCRIPTION OF DRAWINGS

The accompanying drawings are included to provide a further understanding of the present disclosure, and are incorporated in and constitute a part of this specification. The drawings illustrate embodiments of the present disclosure and, together with the description, serve to explain principles of the present disclosure. In the drawings:

FIG. 1 is a block diagram of an electronic apparatus according to an embodiment;

FIG. 2 is a drawing of an electronic apparatus according to various embodiments;

FIG. 3A is a perspective view of an electronic apparatus according to an embodiment;

FIG. 3B is a perspective view of an electronic apparatus according to an embodiment;

FIG. 3C is a perspective view of an electronic apparatus according to an embodiment;

FIG. 4 is an exploded perspective view of an electronic apparatus according to an embodiment;

FIG. 5 is a cross-sectional view of an electronic apparatus according to an embodiment;

FIG. 6 is a cross-sectional view of a protective film according to an embodiment;

FIG. 7 shows the result of measuring the reflectance of an anti-reflection layer according to an embodiment; and

FIG. 8 is a drawing schematically illustrating a step of forming some components of a protective film according to an embodiment.

### DETAILED DESCRIPTION

In this specification, it will be understood that when an element (or a region, a layer, a portion, or the like) is referred to as being “on”, “connected to” or “coupled to” another element, it may be directly disposed on, connected to, or coupled to the other element, or other elements may be disposed therebetween.

Like reference numerals or symbols refer to like elements throughout. In the drawings, the thickness, ratio, and size of the elements are exaggerated for effectively describing the technical contents. As used herein, an expression “a and/or b” should be understood as including only a, only b and both a and b. As used herein, expressions “at least one of a, b, and c” and “at least one of a, b, or c” should be understood as including only a, only b, only c, both a and b, both a and c, both b and c, or all of a, b, and c.

It will be understood that although the terms “first”, “second”, etc. may be used herein to describe various elements, the elements are not to be limited by these terms. These terms are only used to distinguish one element from another element. For instance, a first element discussed below could be termed a second element without departing from the scope of the present disclosure. Similarly, a second element could be termed a first element. In this specification, the singular expressions “a”, “an” and “the” are intended to include the plural forms as well, unless the context clearly indicates otherwise.

In addition, the terms “below”, “under”, “on the lower side”, “above”, “over”, “on the upper side”, or the like may be used to describe the relationships between the elements illustrated in the drawings. These terms are relative concepts and are described on the basis of the directions indicated in the drawings.

It will be further understood that the terms “comprises”, “includes”, “has”, “comprising”, “including”, and “having”, when used in this specification, specify the presence of stated features, numbers, steps, operations, elements, components or combinations thereof, but do not preclude the possibility of the presence or addition of one or more other features, numbers, steps, operations, elements, components, and/or combinations thereof.

In this specification, the term “directly disposed” may mean there is no intervening layer, film, region, substrate, or the like between one portion such as a layer, film, region, substrate, or the like and the other portion. For example, the term “directly disposed” may refer to being disposed between two layers or two members without using an additional member such as an adhesion member.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described with reference to the accompanying drawings.

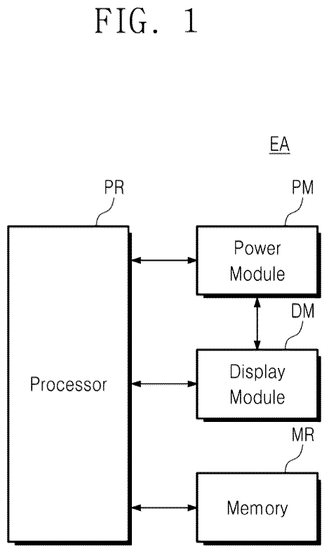

FIG. 1 is a block diagram of an electronic apparatus according to an embodiment. Referring to FIG. 1, an electronic apparatus EA according to an embodiment may include a display module DM, a processor PR, a memory MR, and a power module PM.

The processor PR may include at least one of a central processing unit (CPU), an application processor (AP), a graphics processing unit (GPU), a communication processor (CP), an image signal processor (ISP), or a controller.

In the memory MR, data information necessary for operation of the processor PR or the display module DM may be stored. When the processor PR runs an application stored in the memory MR, image data signals and/or input control signals may be transmitted to the display module DM, and the display module DM may process the received signals to output image information through a display screen.

The power module PM may include a power supply module such as a power adapter or a battery device, and a power-converting module that converts power supplied by the power supply module and generates power necessary for operation of the electronic apparatus EA.

At least one of the components of the electronic apparatus EA may be included in a display device according to an embodiment. In addition, some individual modules included in one functional module may be included in the display device, and others may be provided separately from the display device. The processor PR, the memory MR, and the power module PM may be provided in the form of a device other than the display device in the electronic apparatus EA.

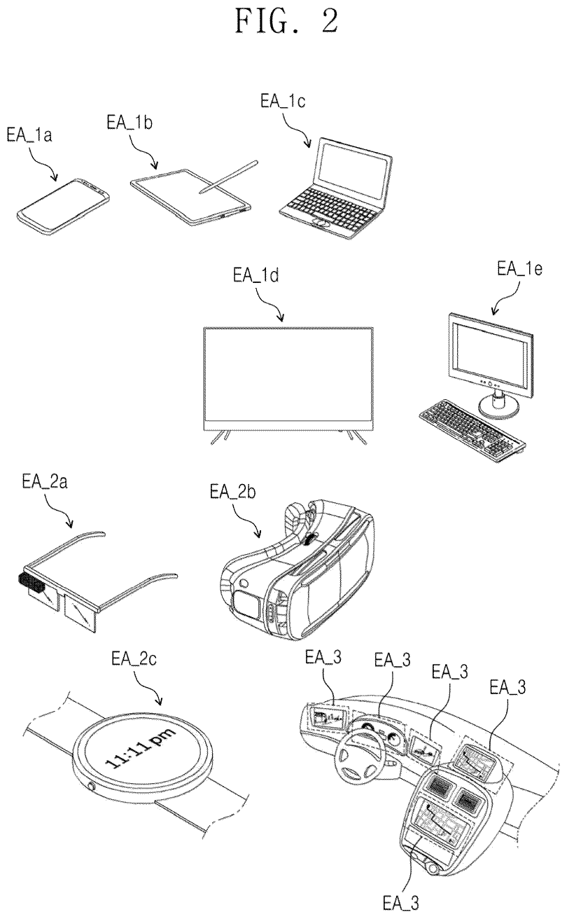

FIG. 2 shows schematic views of an electronic apparatus according to various embodiments.

Referring to FIG. 2, various electronic apparatuses including the display device according to an embodiment may not only include electronic apparatuses for displaying images, such as a smartphone EA_1a, a tablet PC EA_1b, a laptop computer EA_1c, a TV EA_1d, and a desktop monitor EA_1e, but also include wearable electronic apparatuses including a display module, such as smart glasses EA_2a, a head-mounted display EA_2b, and a smart watch EA_2c, electronic apparatuses for a vehicle EA_3 including a display module such as a car dashboard, a center fascia, a center information display (CID) on the dashboard, and a room mirror display, and the like.

The display device according to an embodiment may be applied to various electronic apparatuses. In addition to the display device, the electronic apparatus according to an embodiment may further include a module or a device having another additional function.

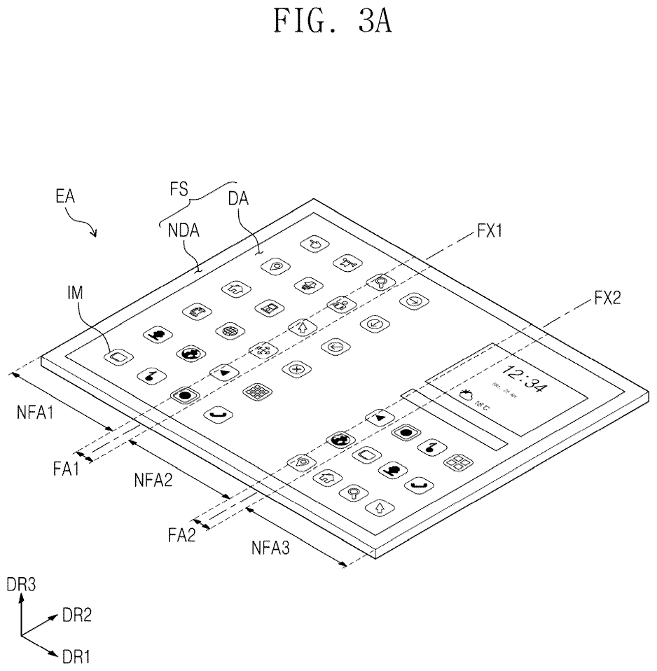

FIGS. 3A to 3C are perspective views illustrating an electronic apparatus according to an embodiment. FIG. 3A is a perspective view illustrating an unfolded state of the electronic apparatus according to an embodiment. FIGS. 3B and 3C are perspective views illustrating folding operation of the electronic apparatus according to an embodiment.

The electronic apparatus EA according to an embodiment may be activated in response to electrical signals. FIG. 3A exemplarily illustrates that the electronic apparatus EA is a portable electronic device. An embodiment is not limited thereto, and the electronic apparatus may be, for example, a personal computer, a laptop computer, a personal digital assistant, a game console, a television, a monitor, an outdoor billboard, a car navigation, a wearable device, or the like.

The electronic apparatus EA may include a display surface FS defined by a first directional axis DR1 and a second directional axis DR2 crossing the first directional axis DR1. The electronic apparatus EA may provide an image IM to a user through the display surface FS. The electronic apparatus EA may display the image IM on the display surface FS toward a direction of a third directional axis DR3. The image IM may include a dynamic image and a still image.

In this specification, directions indicated by the first to third directional axes DR1, DR2, and DR3 may be relative concepts, and may be changed to other directions. In addition, the directions indicated by the first to third directional axes DR1, DR2, and DR3 may be described as first to third directions, and may be denoted as the same reference numerals or symbols.

In this specification, the first directional axis DR1 and the second directional axis DR2 may cross each other, and the third directional axis DR3 may be a normal direction of a plane defined by the first directional axis DR1 and the second directional axis DR2. A thickness direction of the electronic apparatus EA may be a direction parallel to the third directional axis DR3. The thickness direction of the electronic apparatus EA may be denoted as the same reference numeral or symbol as the third directional axis DR3. A front surface (or upper surface) and a rear surface (or lower surface) may be opposed to each other in the third directional axis DR3, and the normal direction of each of the front surface (or upper surface) and the rear surface (or lower surface) may be parallel to the third directional axis DR3. The front surface (or upper surface) refers to a surface adjacent to the display surface FS, and the rear surface (or lower surface) refers to a surface spaced apart from the display surface FS. An upper side refers to a direction closer to the display surface FS, and a lower side refers to a direction away from the display surface FS.

In this specification, a cross-section refers to a surface parallel to the thickness direction DR3. A plane refers to being perpendicular to the thickness direction DR3, and parallel to the plane defined by the first directional axis DR1 and the second direction axis DR2.

In this specification, one component overlapping another component refers to overlapping on a plane. In addition, one component overlapping another component is not limited to the case where the one component and the other component have the same area and same shape, and rather includes the case of having different areas and/or different shapes.

The electronic apparatus EA may detect an external input applied from the outside. The external input may include various types of inputs provided from the outside of the electronic apparatus EA. For example, the external input may include not only an external input applied by contact of a part of a user's body such as a hand, but also an external input applied in proximity to, or adjacent at a predetermined distance to the electronic apparatus EA (for example, hovering). In addition, the external input may have various forms such as power, pressure, temperature, and light.

The display surface FS may include a display region DA and a non-display region NDA. The display region DA may be a region activated in response to electrical signals. The display region DA may be a region on which the image IM is displayed, and a region capable of detecting various types of external inputs.

The display region DA may include a flat surface defined by the first directional axis DR1 and the second directional axis DR2. However, this is an example, and the shape of the display region DA is not limited thereto. For example, the display region DA may also include a curved surface bent from at least one side of the flat surface defined by the first directional axis DR1 and the second directional axis DR2. The display region DA may further include curved surfaces bent from at least two sides of the flat surface defined by the first directional axis DR1 and the second directional axis DR2, for example, four curved surfaces respectively bent from four sides of the flat surface.

The non-display region NDA may be adjacent to the display region DA. The non-display region NDA may have a light transmittance lower than light transmittance of the display region DA. The non-display region NDA may have a predetermined color. The non-display region NDA may surround the display region DA. Accordingly, the shape of the display region DA may be substantially defined by the non-display region NDA. However, this is an example, and the non-display region NDA may also be adjacent to only one side of the display region DA, and may also be omitted.

In an embodiment, the electronic apparatus EA may be flexible. The meaning of being “flexible” may indicate bendable characteristics, and may include everything from a structure being completely foldable to a structure being bendable to several nanometers. For example, the electronic apparatus EA may be a foldable apparatus. Unlike this, the electronic apparatus EA may be a rigid apparatus.

The electronic apparatus EA may include a plurality of folding regions FA1 and FA2 and a plurality of non-folding regions NFA1, NFA2, and NFA3 extending from the folding regions FA1 and FA2. For example, a first non-folding region NFA1, a first folding region FA1, a second non-folding region NFA2, a second folding region FA2, and a third non-folding region NFA3 may be defined along the first direction DR1. The electronic apparatus EA according to an embodiment may include the first non-folding region NFA1, the second non-folding region NFA2, and the third non-folding region NFA3 spaced apart from each other in the first direction DR1 with the first folding region FA1 or the second folding region FA2 therebetween. For example, the first non-folding region NFA1 may be on one side of the first folding region FA1 along the first direction DR1, and the second non-folding region NFA2 may be on the other side of the first folding region FA1 along the first direction DR1. In addition, the second non-folding region NFA2 may be on one side of the second folding region FA2 along the first direction DR1, and the third non-folding region NFA3 may be on the other side of the second folding region FA2 along the first direction DR1.

FIG. 3A, etc. illustrates an embodiment of the electronic apparatus EA including two folding regions FA1 and FA2, but an embodiment is not limited thereto, and three or more folding regions may be defined in the electronic apparatus EA. For example, the electronic apparatus according to an embodiment may include three or more folding regions, and also include four or more non-folding regions such that one folding region is between two non-folding regions. In addition, the electronic apparatus EA may also have one folding region defined therein.

The electronic apparatus EA may be provided in a first mode, a second more, and a third mode. The first mode may be a non-folding mode. In the first mode, the electronic apparatus EA may be unfolded such that the first to third non-folding regions NFA1, NFA2, and NFA3 are arranged side by side. In FIG. 3A, the electronic apparatus EA in the first mode may be illustrated. The second mode and the third mode may be folding modes. In the second mode and the third mode, the electronic apparatus EA may be folded such that the first to third non-folding regions NFA1, NFA2, and NFA3 overlap each other. In the second mode and the third mode, the first and second folding regions FA1 and FA2 may each be in-folded or out-folded along a folding direction. The second mode and the third mode may differ from each other in the folding direction of the first folding region FA1. FIG. 3B may illustrate the electronic apparatus EA in the second mode, and FIG. 3C may illustrate the electronic apparatus EA in the third mode. In the second mode, the first folding region FA1 may be out-folded, and the second folding region FA2 may be in-folded. In the third mode, the first folding region FA1 and the second folding region FA2 may be both in-folded.

Referring to FIGS. 3A and 3B, the first folding region FA1 may be folded with respect to a first folding axis FX1 parallel to the second direction DR2. The first folding region FA1 may be out-folded such that a rear surface of the first non-folding region NFA1 and a rear surface of the second non-folding region NFA2 face each other, and a front surface of the first non-folding region NFA1 faces outwards. The front surface of the first non-folding region NFA1 may be a portion of the display surface FS, and may provide the image IM to a user. The first folding region FA1 may be out-folded with a radius of curvature of about 4 mm in the second mode.

The second folding region FA2 may be folded with respect to a second folding axis FX2 parallel to the second direction DR2. The second folding region FA2 may be in-folded such that a front surface of the second non-folding region NFA2 and a front surface of the third non-folding region NFA3 face each other. The second folding region FA2 may be in-folded with a radius of about 2 R (that is, a radius of curvature of about 2 mm or less) in the second mode. For example, the second folding region FA2 may be in-folded with a radius of about 1.5 R (that is, a radius of curvature of about 1.5 mm) in the second mode. In the second mode where the first folding region FA1 is out-folded and the second folding region FA2 is in-folded, only a portion of the display surface FS may be exposed to the outside.

Referring to FIGS. 3A and 3C, the first folding region FA1 may be in-folded with respect to the first folding axis FX1 parallel to the second direction DR2. In the third mode, the first folding region FA1 may be in-folded such that the front surface of the first non-folding region NFA1 and a rear surface of the third non-folding region NFA3 face each other, and the rear surface of the first non-folding region NFA1 faces outwards. For example, the first folding region FA1 may be in-folded with a radius of about 4 R (that is, a radius of curvature of about 4 mm) in the third mode.

The second folding region FA2 may be in-folded with respect to a second folding axis FX2 parallel to the second direction DR2. The second folding region FA2 may be in-folded such that the front surface of the second non-folding region NFA2 and the front surface of the third non-folding region NFA3 face each other. The front surface of the second non-folding region NFA2 and the front-surface of the third non-folding region NFA3 may each be a surface on which the image IM is displayed.

The second folding region FA2 may be in-folded with a radius of curvature having a radius of about 2 R or less in the third mode. For example, the second folding region FA2 may be in-folded with a radius of curvature of about 1.5 R. In the third mode where both of the first and second folding regions FA1 and FA2 are in-folded, the display surface FS may not be exposed to the outside. FIG. 3C exemplarily illustrates that the first folding region FA1 is folded after the second folding region FA2 is folded, but the folding order of the folding regions FA1 and FA2 is not limited thereto. For example, the second folding region FA2 may also be folded after the first folding region FA1 is folded.

Meanwhile, the multi-folded state is not limited to the illustrations in FIGS. 3B and 3C, and various folding types may be included. In an embodiment, the out-folding operation and in-folding operation may be performed simultaneously, and also, either one of the out-folding operation or the in-folding operation may be performed.

The electronic apparatus EA according to an embodiment may be provided to repeat unfolding to in-folding operations or unfolding to out-folding operations, but an embodiment is not limited thereto. The electronic apparatus EA according to an embodiment may be provided to select any one among the unfolding, in-folding, and out-folding operations.

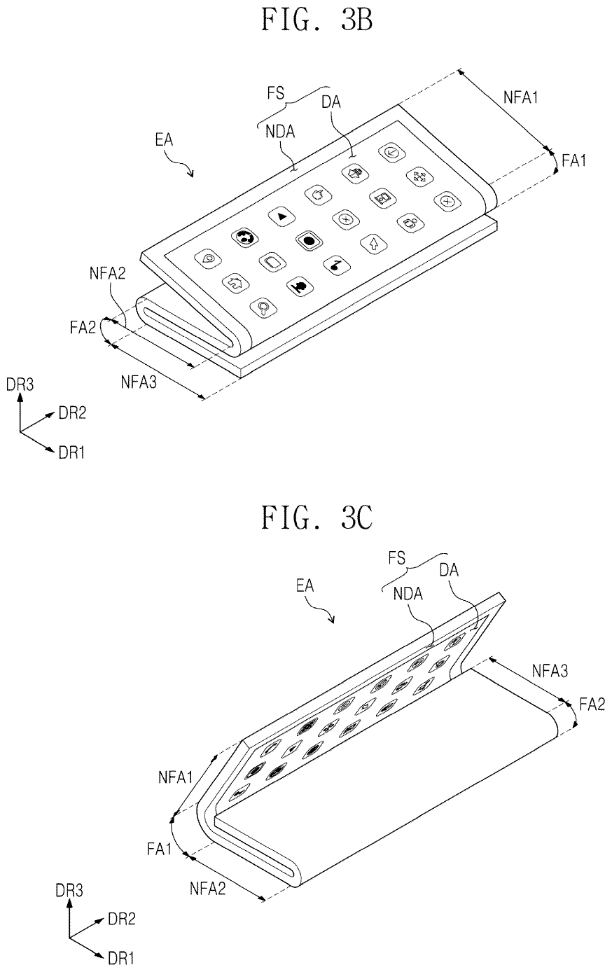

FIG. 4 is an exploded perspective view of an electronic apparatus according to an embodiment. FIG. 4 may be an exploded perspective view of the electronic apparatus EA illustrated in FIG. 3A. Referring to FIG. 4, the electronic apparatus EA may include a display device DD and a housing HAU in which at least a portion of the display device DD is accommodated.

The display device DD may include a display module DM and a window module WM on the display module DM. The window module WM may include a window CW and a protective film PL.

The display module DM may display the image IM (see FIG. 3A) in response to electrical signals, and may transmit/receive information based on an external input. The image IM (see FIG. 3A), generated in the display module DM, may penetrate the window module WM to be provided to a user. An active region DM-AA and a peripheral region DM-NAA may be defined in the display module DM.

The active region DM-AA may be defined as a region that emits images provided from the display module DM. The active region DM-AA of the display module DM may correspond to at least a portion of the display region DA (see FIG. 3A).

In the peripheral region DM-NAA, a driving circuit, driving wiring, or the like may be disposed in order to drive the active region DM-AA. The peripheral region DM-NAA may be adjacent to the active region DM-AA. For example, the peripheral region DM-NAA may surround the active region DM-AA. However, this is an example, and the peripheral region DM-NAA may be defined in various shapes, and is not limited to any one embodiment.

At least one folding part FP1-D or FP2-D and non-folding parts NFP1-D, NFP2-D, and NFP3-D, which are spaced apart from each other with the at least one folding part FP1-D or FP2-D therebetween, may be defined along one direction in the display module DM. For example, a first non-folding part NFP1-D, a first folding part FP1-D, a second non-folding part NFP2-D, a second folding part FP2-D, and a third non-folding part NFP3-D may be defined along the second direction DR2 in the display module DM. The first and second folding parts FP1-D and FP2-D may be portions corresponding to the first and second folding regions FA1 and FA2 (see FIG. 3A), respectively. The first to third non-folding parts NFP1-D, NFP2-D, and NFP3-D may be portions corresponding to the first to third non-folding regions NFA1, NFA2 and NFA3 (see FIG. 3A), respectively.

The first folding part FP1-D may be a portion that is folded with respect to the first folding axis FX1 (see FIG. 3A). The first non-folding part NFP1-D and the second non-folding part NFP2-D may be spaced apart from each other with the first folding part FP1-D therebetween. The second folding part FP2-D may be a portion that is folded with respect to the second folding axis FX2 (see FIG. 3A). The second non-folding part NFP2-D and the third non-folding part NFP3-D may be spaced apart from each other with the second folding part FP2-D therebetween. In the first mode, the display device DD may be folded such that the first to third non-folding parts NFP1-D, NFP2-D, and NFP3-D overlap each other. In the first mode, the first folding part FP1-D may be out-folded, and the second folding part FP2-D may be in-folded. In the second mode, the display device DD may be unfolded such that the first to third non-folding parts NFP1-D, NFP2-D, and NFP3-D are arranged side by side on a plane.

The window CW may cover the entire upper surface of the display module DM. The window CW may be optically transparent. In an embodiment, the window CW may be used as a cover window of the electronic apparatus EA. The window CW may be folded with respect to the first and second folding axes FX1 and FX2 (see FIG. 3A). The window CW may have flexibility enabling repeating of folding and unfolding operations. For example, the window CW may be a glass substrate. The window CW may be a tempered glass substrate. In addition, the window CW may be an ultra-thin glass.

The protective film PL may be on the window CW. The protective film PL may be folded with respect to the first and second folding axes FX1 and FX2 (see FIG. 3A). The protective film PL according to an embodiment may include a hard coating layer HC and an anti-reflection layer ARL to be described later, and may thus have characteristics that prevent damage such as cracks occurring during folding operation at low curvature and facilitate repeated folding and unfolding operations. The folding operation at low curvature may refer to being folded to have a small radius of curvature of about 1.5 mm. Accordingly, the display device DD including the protective film PL according to an embodiment and the electronic apparatus EA including the same may have excellent reliability.

The housing HAU may include a material that is relatively high in rigidity. For example, the housing HAU may include a plurality of frames and/or plates made of glass, plastic, or metal. The housing HAU may provide a predetermined accommodating space. The display module DM may be accommodated in the accommodating space, and may thus be protected from external impact.

Although not illustrated in the drawing, the electronic apparatus EA may further include at least one adhesion layer. For example, the adhesion layer may be between the display module DM and the window CW, and/or between the window CW and the protective film PL. The adhesion layer may include a pressure sensitive adhesive (PSA), an optically clear adhesive (OCA) film, or an optically clear adhesive resin (OCR) layer. However, this is an example, and an embodiment is not limited thereto.

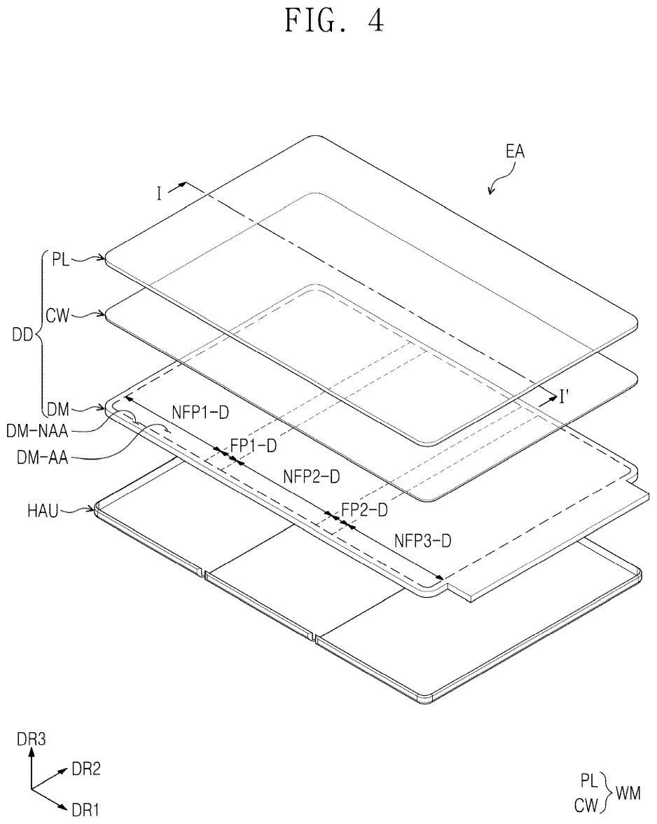

FIG. 5 is a cross-sectional view of an electronic apparatus according to an embodiment. FIG. 5 may be a cross-sectional view illustrating a portion corresponding to line I-I′ of FIG. 4. For the convenience of description, FIG. 5 illustrates components of the electronic apparatus EA with the housing HAU (see FIG. 4) being omitted.

Referring to FIG. 5, the electronic apparatus EA may include a display device DD, and may further include a lower module LM, a lower adhesion layer AP-D, and a lower protection layer DF. The lower module LM, the lower adhesion layer AP-D, and the lower protection layer DF may be between the display device DD and the housing HAU (see FIG. 4).

The lower module LM may be under a display module DM. The lower module LM may include a support plate MP and a lower supporting member BSM. The configuration of the lower module LM, illustrated in FIG. 5, is an example, and in the electronic apparatus EA according to an embodiment, the combination of components included in the lower module LM may vary according to the size of the electronic apparatus EA, the shape of the electronic apparatus EA, the operation characteristics of the electronic apparatus EA, or the like.

The support plate MP may include a metal material or a polymer material. For example, the support plate MP may include stainless steel, aluminum, or an alloy thereof. Unlike this, the support plate MP may include a polymer material. A plurality of openings OP may be defined in the support plate MP. The support plate MP may include an opening pattern OP-PT in which the plurality of openings OP is defined. For example, two opening patterns OP-PT may be formed overlapping the first folding region FA1 and the second folding region FA2, respectively.

The lower supporting member BSM may include a supporting member SPM and a filling part SAP. On a plane, the supporting member SPM may be a component that overlaps almost the entire region of the display module DM. The filling part SAP may be a component that is on the outer side of the supporting member SPM and overlaps the outer perimeter of the display module DM.

The supporting member SPM may include at least one of a supporting layer SP, a cushion layer CP, a shielding layer EMP, or an interlayer-bonding layer ILP. The configuration of the supporting member SPM, illustrated in FIG. 5, is an example, and an embodiment is not limited thereto. For example, some of the supporting layer SP, the cushion layer CP, the shielding layer EMP, and the interlayer-bonding layer ILP may be omitted, or the stacking order thereof may be changed to another order different from that of FIG. 5, or an additional component other than the components illustrated in the drawing may be further included in the supporting member SPM.

The supporting layer SP may include a metal material or a polymer material. The supporting layer SP may be under the support plate MP. For example, the supporting layer SP may be a thin-film metal substrate. The supporting layer SP may include first to third sub-supporting layers SP1, SP2, and SP3 spaced apart from each other in a first direction DR1. The first sub-supporting layer SP1 and the second sub-supporting layer SP2 may be spaced apart from each other at a portion corresponding to the first folding axis FX1 (see FIG. 3A). The second sub-supporting layer SP2 and the third sub-supporting layer SP3 may be spaced apart from each other at a portion corresponding to the second folding axis FX2 (see FIG. 3A). The first sup-supporting layer SP1 and the third sub-supporting layer SP3 may be spaced apart from each other in the first direction DR1 with the second sub-supporting layer SP2 therebetween. Since the supporting layer SP is provided as the first to third sub-supporting layers SP1, SP2, and SP3 spaced apart from each other in the first and second folding regions FA1 and FA2, folding characteristics of the electronic apparatus EA may be improved.

The cushion layer CP may be under the supporting layer SP. The cushion layer CP may prevent pressure and plastic deformation on the support plate MP due to external impact and force. The cushion layer CP may improve impact resistance of the electronic apparatus EA. The cushion layer CP may include an elastomer such as sponge, foam, or a urethane resin. In addition, the cushion layer CP may include at least one of an acrylate-based polymer, a urethane-based polymer, a silicon-based polymer, or an imide-based polymer. However, this is an example, and an embodiment is not limited thereto.

The cushion layer CP may include first to third sub-cushion layers CP1, CP2, and CP3 spaced apart from each other in the first direction DR1. The first sub-cushion layer CP1 and the second sub-cushion layer CP2 may be spaced apart from each other at a portion corresponding to the first folding axis FX1 (see FIG. 3A). The second sub-cushion layer CP2 and the third sub-cushion layer CP3 may be spaced apart from each other at a portion corresponding to the second folding axis FX2 (see FIG. 3A). The first sub-cushion layer CP1 and the third sub-cushion layer CP3 may be spaced apart from each other with the second sub-cushion layer CP2 therebetween in the first direction DR1. Since the cushion layer CP is provided as the first to third sub-cushion layers CP1, CP2, and CP3 spaced apart from each other in the first and second folding regions FA1 and FA2, folding characteristics of the electronic apparatus EA may be improved.

The shielding layer EMP may be an electromagnetic shielding layer or a heat dissipation layer. In addition, the shielding layer EMP may function as a bonding layer.

The interlayer-bonding layer ILP may bond the support plate MP and the components of the supporting member SPM. The interlayer-bonding layer ILP may be provided in the form of a bonding resin layer or an adhesive tape. FIG. 5 illustrates that the interlayer-bonding layer ILP is provided in three parts spaced apart from each other at portions corresponding to the first and second folding axes FX1 and FX2 (see FIG. 3A), but an embodiment is not limited thereto. Unlike what is illustrated in the drawing, the interlayer-bonding layer ILP may be provided as one layer which is not separated in the regions corresponding to the first and second folding axes FX1 and FX2 (see FIG. 3A).

The filling part SAP may be on the outer sides of the supporting layer SP and the cushion layer CP. The filling part SAP may be between the support plate MP and the housing HAU (see FIG. 4). The filling part SAP may fill space between the support plate MP and the housing HAU (see FIG. 4) and fix the support plate MP.

The lower protection layer DF may be between the display module DM and the support plate MP. The lower protection layer DF may be a component under the display module DM to protect a rear surface of the display module DM. The lower protection layer DF may overlap the entire surface of the display module DM. The lower protection layer DF may include a polymer material. For example, the lower protection layer DF may be a polyimide film or a polyethylene terephthalate film. However, this is an example, and the lower protection layer DF is not limited thereto.

The lower adhesion layer AP-D may be between the support plate MP and the lower protection layer DF. The support plate MP and the lower protection layer DF may be bonded through the lower adhesion layer AP-D. The lower adhesion layer AP-D may include a pressure sensitive adhesive (PSA), an optically clear adhesive (OCA) film, or an optically clear adhesive resin (OCR) layer. However, this is an example, and an embodiment is not limited thereto. Unlike what is illustrated in the drawing, the lower adhesion layer AP-D may also be omitted.

The display module DM may include a display panel DP and an input-sensing part TP on the display panel DP. The display panel DP may be a component that substantially generates images. The display panel DP according to an embodiment may be folded with respect to the folding axes FX1 and FX2 (see FIG. 3A).

The input-sensing part TP may detect an external input and convert the external input into a predetermined input signal, and may provide the input signal to the display panel DP. For example, the input-sensing part TP may be a touch-sensing part that detects a touch. The input-sensing part TP may recognize a direct touch of a user, an indirect touch of a user, a direct touch of an object, an indirect touch of an object, or the like.

The input-sensing part TP may detect at least one of a position of a touch or a strength (pressure) of the touch applied from the outside. In an embodiment, the input-sensing part TP may have various structures or may include various materials, and is not limited to any one embodiment. For example, the input-sensing part TP may detect the external input in a capacitance manner. The display panel DP may receive input signals from the input-sensing part TP, and may generate an image corresponding to the input signals.

The display module DM may further include an optical layer RCL between the display panel DP and the window CW. The optical layer RCL may be on the input-sensing layer TP. The optical layer RCL may be a layer that decreases reflectance of external light incident from the outside. The optical layer RCL may be formed on the input-sensing layer TP through a continuous process. The optical layer RCL may include a polarization plate or a color filter layer. For example, the optical layer RCL may include at least one of a phase retarder, a polarizer, a polarizing film, or a polarizing filter. Unlike this, the optical layer RCL may include a plurality of color filters in a predetermined arrangement, and a black matrix adjacent to the color filters.

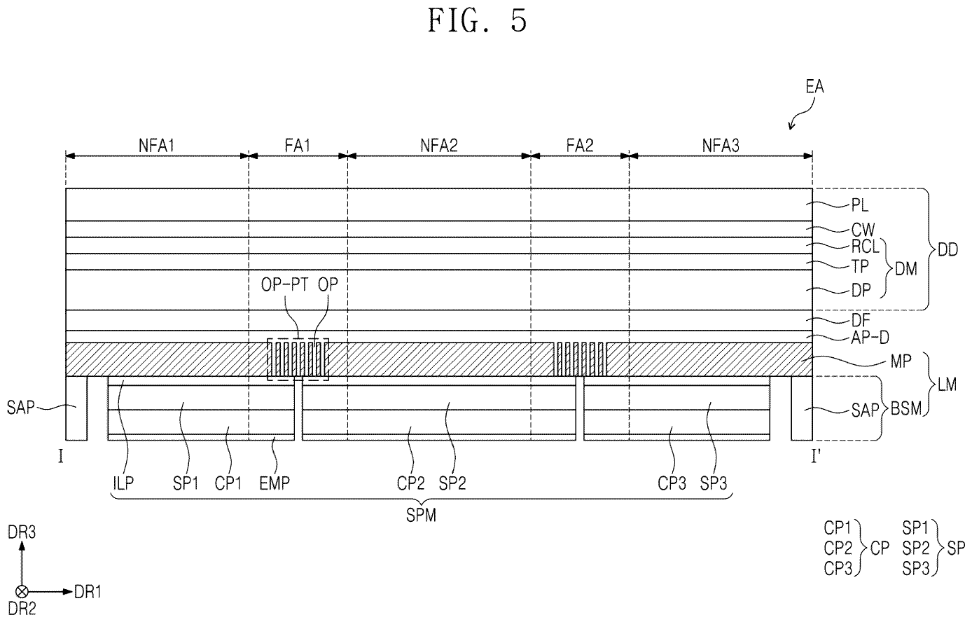

FIG. 6 is a cross-sectional view of a protective film according to an embodiment. FIG. 6 may be a cross-sectional view particularly illustrating the configuration of the protective film PL according to an embodiment.

Referring to FIG. 6, the protective film PL according to an embodiment includes a base layer BL, a hard coating layer HC, and an anti-reflection layer ARL. The protective film PL according to an embodiment may have characteristics that facilitate repeated folding and unfolding operations while maintaining low-reflection characteristics. The protective film PL may not include a separate functional layer such as an anti-fingerprint layer. For example, the protective film PL may not have a functional layer such as an anti-fingerprint layer on the anti-reflection layer ARL, but an embodiment is not limited thereto.

The base layer BL may be on the window CW (see FIG. 5). The base layer BL may be a member providing a base surface having the hard coating layer HC and the anti-reflection layer ARL thereon. The base layer BL may serve to support the hard coating layer HC and the anti-reflection layer ARL, and may thus improve durability of the protective film PL. The base layer BL may be transparent. For example, the base layer BL may be a polymer film having flexibility. The base layer may include at least one of polyethylene terephthalate, polyimide, polyacrylate, polymethylmethacrylate, polycarbonate, polyethylenenaphthalate, polyvinylidene chloride, polyvinylidene difluoride, polystyrene, or an ethylene vinylalcohol copolymer. For example, the base layer may be polyethylene terephthalate. In an embodiment, the base layer BL may have a thickness of about 65 μm. However, this is an example, and the thickness of the base layer BL is not limited thereto.

The hard coating layer HC may be on the base layer BL. The hard coating layer HC may improve durability of the protective film PL and provide structural strength. The hard coating layer HC may include a hard coating resin formed from at least one of an organic composition, an inorganic composition, or an organic-inorganic complex composition. For example, a hard coating agent included in the hard coating layer HC may be a hard coating composition including at least one of an acrylate-based compound, a siloxane compound, or a silsesquioxane compound.

In addition, the hard coating agent may further include an inorganic particle. The inorganic particle included in the hard coating agent may be provided to improve hardness of the hard coating layer HC. The inorganic particle may include at least one of SiO₂, TiO₂, Al₂O₃, ZrO₂, ZnO, AlN, or Si₃N₄. The inorganic particle may be surface-treated with an organic material such as silane in order to increase dispersion in the hard coating composition.

In an embodiment, the hard coating layer HC may have a luminous reflectance of about 1.0% or less. For example, the hard coating layer HC may have a specular component included (SCI) reflectance of about 1.0% or less. The SCI reflectance may be a reflectance for light with a wavelength of about 550 nm. Since the hard coating layer HC has a low reflectance that is a SCI reflectance of about 1.0% or less, the display device DD (see FIG. 5) may have improved display quality.

The anti-reflection layer ARL may be on the hard coating layer HC. The anti-reflection layer ARL may be directly provided onto the hard coating layer HC. The anti-reflection layer ARL may be a coating layer that decreases reflection of light and increases transmittance of light. The anti-reflection layer ARL may be a layer on the uppermost part of the protective film PL. Accordingly, the anti-reflection layer ARL may be on the outermost side of the display device DD (see FIG. 5).

The anti-reflection layer ARL may be provided as a single layer. The anti-reflection layer ARL may have a thickness T_{AR} of about 95 nm or larger and about 105 nm or smaller. For example, the thickness of the anti-reflection layer ARL may be about 100 nm. The anti-reflection layer AR may have excellent low-reflection (anti-reflection) characteristics, and may facilitate repeated folding and unfolding operations in the above-described thickness T_{AR} range. Therefore, the electronic apparatus EA (see FIG. 3A, etc.) including the anti-reflection layer ARL with the above-described thickness T_{AR} may have excellent reliability and display quality.

The anti-reflection layer ARL may include a silsesquioxane cage polymer. The silsesquioxane cage polymer may be formed from components including a fluorine-based silsesquioxane and an acrylate-based monomer. In this specification, “~~”-based resin means including a functional group of “~~”. The anti-reflection layer ARL may be formed by polymerization and deposition of the fluorine-based silsesquioxane and the acrylate-based monomer on the hard coating layer HC.

The anti-reflection layer ARL may be formed by a dry process. For example, the anti-reflection layer ARL may be formed using atomic and/or molecular-level vacuum deposition polymerization technology. The anti-reflection layer ARL may be formed by polymerizing a first material that is the fluorine-based silsesquioxane and a second material that is the acrylate-based monomer in a vacuum state to deposit on the hard coating layer HC. The fluorine-based silsesquioxane and the acrylate-based monomer may be polymerized by a photo-radical polymerization reaction to form a silsesquioxane cage polymer. The polymerization of the fluorine-based silsesquioxane and the acrylate-based monomer may be performed in a vacuum state. Since the anti-reflection layer ARL according to an embodiment is formed by a vacuum deposition polymerization method enabling control of micro structure, the fluorine-based silsesquioxane and the acrylate-based monomer that are organic materials may be polymerized without property change to form into a thin film with a uniform thickness in nanometers.

The fluorine-based silsesquioxane may include at least one perfluoroalkyl group. In this specification, the perfluoroalkyl group refers to an alkyl group in which a hydrogen atom is substituted with a fluorine atom. The alkyl group may be a straight-chain or branched alkyl group, and may have 1 to 30 carbon atoms. For example, the perfluoroalkyl group may be an alkyl group having 1 to 30 carbon atoms in which all hydrogen atoms are substituted with fluorine atoms.

When the fluorine-based silsesquioxane includes two or more perfluoroalkyl groups, the plurality of perfluoroalkyl groups may be the same or different from each other. The perfluoroalkyl group may be represented by Formula A. By including the perfluoroalkyl group, the fluorine-based silsesquioxane may have excellent compatibility with the acrylate-based monomer, and may provide a low-reflection function and excellent flexibility to the anti-reflection layer ARL.

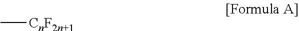

In Formula A, n may be an integer of 4 or greater and 30 or less. For example, in Formula A, n may be 4, but an embodiment is not limited thereto.

The perfluoroalkyl group may be connected to a silicon atom of the fluorine-based silsesquioxane via a linker. The linker may be an ethylene group. The perfluoroalkyl group may be connected to a silicon atom of the fluorine-based silsesquioxane via an ethylene group as a linker.

In an embodiment, the fluorine-based silsesquioxane may include 7 silicon atoms in a molecule, and the perfluoroalkyl group may be connected to each of the 7 silicon atoms through an ethylene group as a linker. For example, the fluorine-based silsesquioxane may be represented by Formula 1.

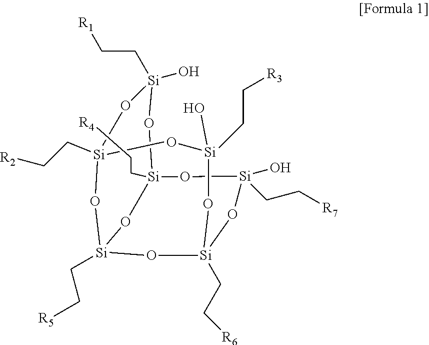

In Formula 1, R₁ to R₇ may be each independently —CₙF₂ₙ₊₁. R₁ to R₇ may each correspond to the above-described perfluoroalkyl group. In Formula 1, n may be an integer of 4 or greater and 30 or less. For example, in Formula 1, at least one of R₁ to R₇ may be —CF₂CF₂CF₂CF₃. In Formula 1, all of R₁ to R₇ may be —CF₂CF₂CF₂CF₃. The fluorine-based silsesquioxane according to an embodiment in which all of R₁ to R₇ of Formula 1 are —CF₂CF₂CF₂CF₃ may be represented by Formula 1-1.

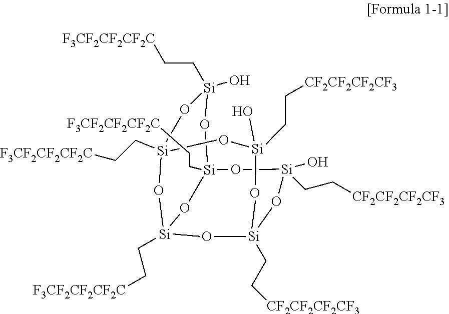

The fluorine-based silsesquioxane according to an embodiment may provide low refractive index characteristics. Accordingly, by including the silsesquioxane cage polymer formed from components including the fluorine-based silsesquioxane according to an embodiment, the anti-reflection ARL may have a refractive index of about 1.37 or greater and about 1.41 or less. The refractive index of the anti-reflection layer ARL may be a refractive index for light with a wavelength of about 550 nm. By including the silsesquioxane cage polymer having low refractive index characteristics, the anti-reflection layer ARL may have excellent anti-reflection characteristics. The anti-reflection layer ARL including the silsesquioxane cage polymer may have a refractive index of about 1.39 with a thickness of about 100 nm, but the refractive index of the anti-reflection layer ARL is not limited thereto. The refractive index of the anti-reflection layer ARL may be adjusted to a range of about 1.37 or greater and about 1.41 or less according to the amount of fluorine included in the fluorine-based silsesquioxane.

In an embodiment, the acrylate-based monomer may include a radical photopolymerization functional group. The acrylate-based monomer may include at least one of a monofunctional reactive monomer or a multifunctional reactive monomer. The acrylate-based monomer according to an embodiment may include at least one of trimethylolpropane trimethacrylate or cyclohexyl methacrylate. Trimethylolpropane trimethacrylate may be represented by Formula 2-1, and cyclohexyl methacrylate may be represented by Formula 2-2.

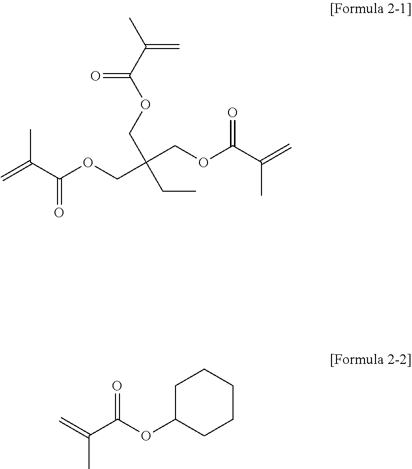

With excellent wear resistance and high volatility, trimethylolpropane trimethacrylate may be suitable for vacuum deposition. Cyclohexyl methacrylate may have high hardness and excellent chemical resistance and heat resistance, and may be suitable for vacuum deposition due to a cyclohexyl group included in a molecule. By including the acrylate-based monomer of trimethylolpropane trimethacrylate represented by Formula 2-1 or of cyclohexyl methacrylate represented by Formula 2-2, the silsesquioxane cage polymer according to an embodiment may provide excellent durability.

In an embodiment, the silsesquioxane cage polymer may have a T₈ cage structure. In the silsesquioxane cage polymer, a perfluoroalkyl group may be connected to 7 silicon atoms among 8 silicon atoms, and an acrylate-based monomer may be connected to one silicon atom. For example, the silsesquioxane cage polymer may be formed from Formula 3.

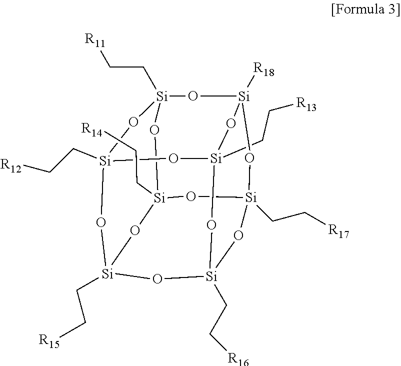

In Formula 3, R₁₁ to R₁₇ may be each independently —CₘF₂ₘ₊₁. R₁₁ to R₁₇ may each correspond to the above-described perfluoroalkyl group. In Formula 3, m may be an integer of 4 or greater and 30 or less. For example, in Formula 3, m may be 4. In Formula 3, at least one of R₁₁ to R₁₇ may be —C₄F₉ (for example, —CF₂CF₂CF₂CF₃). In an embodiment, R₁₁ to R₁₇ may be all the same. For example, in Formula 3, all of R₁₁ to R₁₇ may be —CF₂CF₂CF₂CF₃.

In Formula 3, R₁₈ may be represented by Formula B1 or Formula B2. Formula B1 and Formula B2 may each correspond to the above-described acrylate-based monomer. In Formula B1 and Formula B2, “ [symbol] ” may be a position to which the silicon atom in Formula 3 is connected.

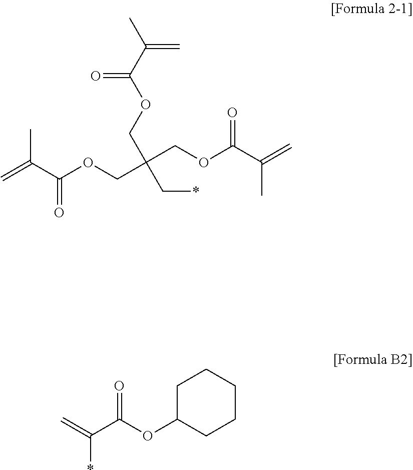

The silsesquioxane cage polymer which is a polymer of Formula 3 may be a polymer of Formula 4-1 or Formula 4-2. In an embodiment, the silsesquioxane cage polymer may include at least one of the silsesquioxane cage polymer which is a polymer of Formula 4-1 or the silsesquioxane cage polymer which is a polymer of Formula 4-2.

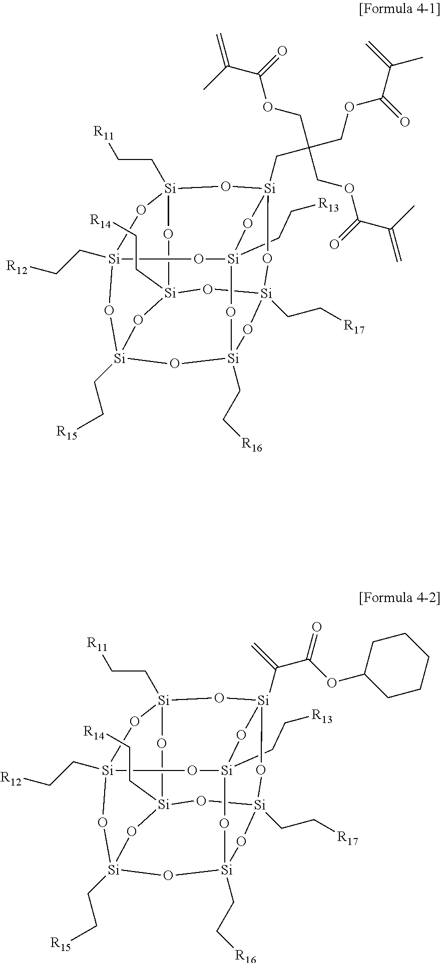

In Formula 4-1 and Formula 4-2, for R₁₁ to R₁₇, the same content as those described in Formula 3 may be applied. For example, in Formula 4-1 and Formula 4-2, all of R₁₁ to R₁₇ may be —C₄F₉ (for example, —CF₂CF₂CF₂CF₃).

In an embodiment, the silsesquioxane cage polymer may include at least one of compounds in Compound Group 1.

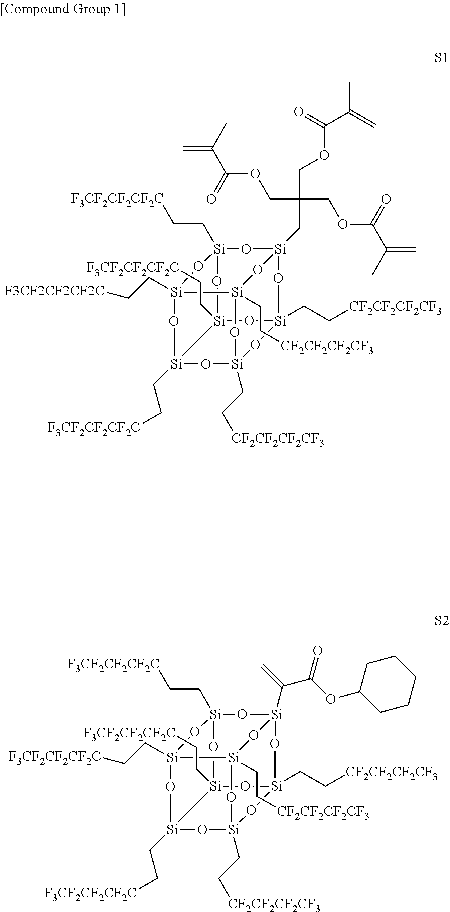

The anti-reflection layer ARL may include the silsesquioxane cage polymer according to an embodiment, and may thus exhibit excellent flexibility as well as provide low-reflection characteristics. Accordingly, the protective film PL may have low-reflection characteristics maintained, and the occurrence of cracks may be suppressed even though folding and unfolding operations are repeated at a low curvature of about 1.5 R. Therefore, the electronic apparatus EA (see FIG. 3A, etc.) including the protective film PL according to an embodiment may have excellent display quality and excellent folding reliability.

In an embodiment, the refractive index and reflectance of the silsesquioxane cage polymer may be adjusted according to the composition ratio of the fluorine-based silsesquioxane and the acrylate-based monomer. As the content of fluorine-based silsesquioxane increases, the silsesquioxane cage polymer may have decreasing refractive index and reflectance and exhibit excellent wear resistance. However, when the content of fluorine-based silsesquioxane becomes excessive during the synthesis of the silsesquioxane cage polymer, compatibility between the fluorine-based silsesquioxane and the acrylate-based monomer may decrease, so that the anti-reflection layer ARL may have decreased transparency. Accordingly, the silsesquioxane cage polymer may be polymerized by adjusting the amounts of the fluorine-based silsesquioxane and the acrylate-based monomer, so that the maximum amount of the fluorine-based silsesquioxane does not exceed about 60 wt %.

For example, the silsesquioxane cage polymer may include the fluorine-based silsesquioxane and the acrylate-based monomer in a weight ratio of about 45:55 to about 60:40 on the basis of the sum of the weight of the fluorine-based silsesquioxane and the weight of the acrylate-based monomer. For example, the weight ratio of the fluorine-based silsesquioxane and the acrylate-based monomer may be about 45:55, but an embodiment is not limited thereto.

For example, the silsesquioxane cage polymer may be formed from components including the fluorine-based silsesquioxane in the amount of about 45 wt % or greater and about 60 wt % or less on the basis of the total amount 100 wt % of the fluorine-based silsesquioxane and the acrylate-based monomer. In addition, the silsesquioxane cage polymer may be formed from components including the acrylate-based monomer in the amount of about 40 wt % or greater and about 55 wt % or less on the basis of the total amount 100 wt % of the fluorine-based silsesquioxane and the acrylate-based monomer.

The anti-reflection layer ARL may have a water contact angle of about 95° or greater, or about 100° or greater. For example, the water contact angle of the anti-reflection layer ARL may be about 95° or greater and about 110° or less, about 100° or greater and about 110° or less, or about 100° or greater and about 105° or less. The water contact angle of the anti-reflection layer ARL may be measured in a state where a reliability test such as a wear resistance test for the anti-reflection layer ARL is not performed, that is, in the early stage of formation of the anti-reflection layer ARL. The anti-reflection layer ARL may have an initial water contact angle satisfying about 95° or greater, exhibiting excellent wear resistance. The anti-reflection layer ARL according to an embodiment may have a luminous reflectance of about 1.5% or less for light with a wavelength of about 550 nm. For example, the anti-reflection layer ARL may have a specular component included (SCI) reflectance of about 1.5% or less, or about 1.0% or less for light with a wavelength of about 550 nm. For example, the SCI reflectance of the anti-reflection layer ARL having a thickness of about 100 nm may be about 1.42%. An embodiment is not limited thereto, and the SCI reflectance of the anti-reflection layer ARL may be about 0.96%. The SCI reflectance of the anti-reflection layer ARL may be adjusted according to the amount of the fluorine-based silsesquioxane included in the silsesquioxane cage polymer. Since the protective film PL includes the anti-reflection layer ARL having a SCI reflectance of about 1.5% or less, the display device DD (see FIG. 5, etc.) may have improved display quality.

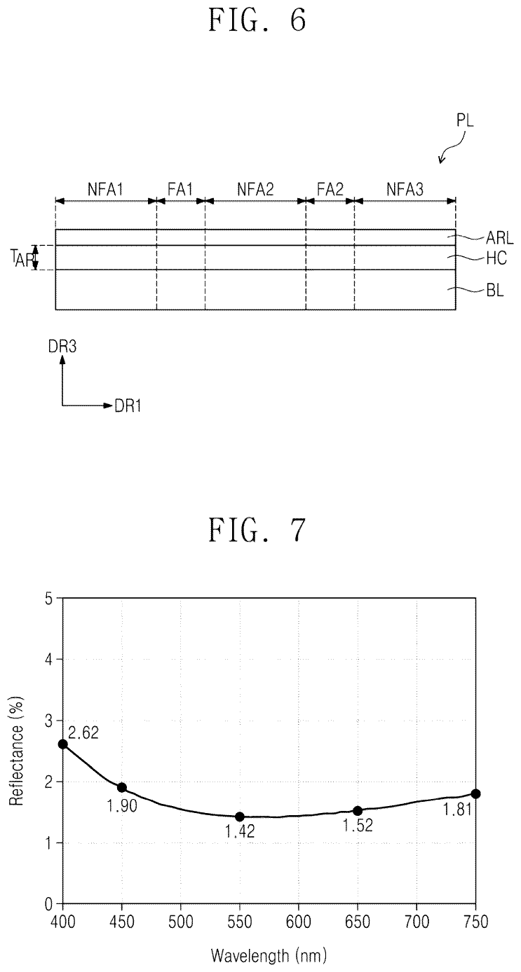

FIG. 7 shows the result of measuring the reflectance of an anti-reflection layer according to an embodiment. FIG. 7 is a graph showing the result of measuring the SCI reflectance for an anti-reflection layer in a wavelength range of about 400 nm to about 750 nm using a vector diagram simulation. FIG. 7 shows the result for the anti-reflection layer according to an embodiment having a refractive index of about 1.39 and a thickness of about 100 nm, and including Compound S1 of Compound Group 1.

Referring to FIGS. 6 and 7, the anti-reflection layer ARL may have a luminous reflectance of about 1.42% to about 2.62% in a wavelength range of about 400 nm to about 750 nm where humans perceive light. For example, the anti-reflection layer ARL according to an embodiment has a reflectance of about 2.62% for light with a wavelength of about 400 nm, and has a reflectance of about 1.90% for light with a wavelength of about 450 nm, and has a reflectance of about 1.42% for light with a wavelength of about 550 nm. In addition, the anti-reflection layer ARL has a reflectance of about 1.52% for light with a wavelength of about 650 nm, and has a reflectance of about 1.81% for light with a wavelength of about 750 nm. It can be seen that the anti-reflection layer ARL according to an embodiment has the lowest reflectance of about 1.42% for light with a wavelength of about 550 nm that human eyes perceive the brightest. By including the silsesquioxane cage polymer, the anti-reflection layer ARL according to an embodiment may have excellent folding characteristics at low curvature, and at the same time, may have a low reflectance of about 1.5% or less for light with a wavelength of about 550 nm. Therefore, the electronic apparatus EA (see FIG. 3A, etc.) including the anti-reflection layer ARL according to an embodiment may provide excellent display quality.

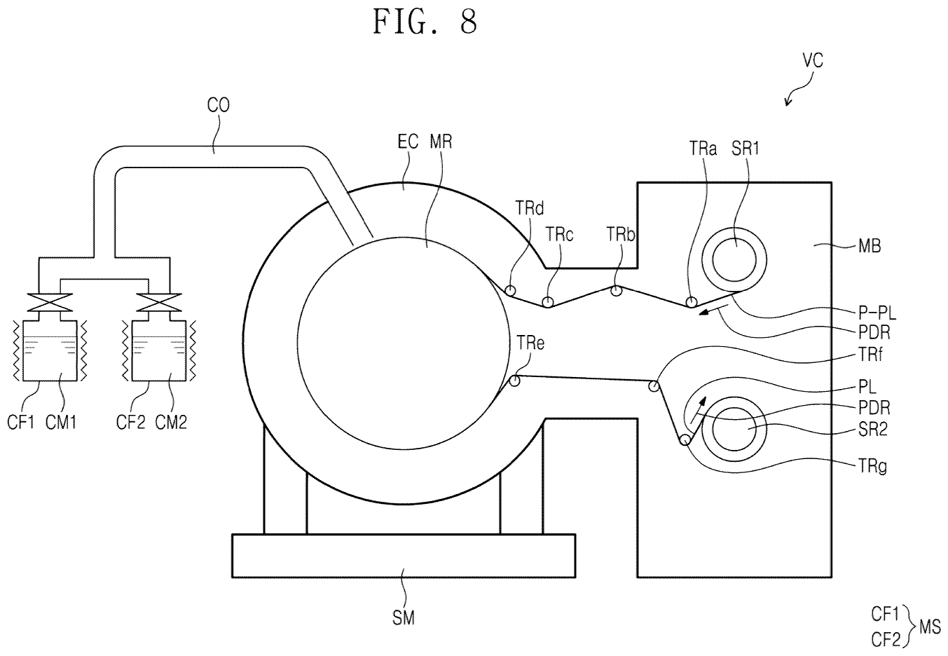

FIG. 8 is a drawing schematically illustrating a step of forming some components of a protective film according to an embodiment. FIG. 8 schematically illustrates a step of manufacturing an anti-reflection layer included in the protective film.

Referring to FIGS. 6 and 8, the protective film PL according to an embodiment may have a hard coating layer HC formed on a base layer BL, and may have an anti-reflection layer ARL formed on the hard coating layer HC. The protective film PL manufactured by a manufacturing method according to an embodiment may be applied to the electronic apparatus EA (see FIG. 3A, etc.).

In an embodiment, the hard coating layer HC may be formed by providing a material for forming the hard coating layer onto the base layer BL. The material for forming the hard coating layer may be provided onto the base layer BL through a slit coating method. The material for forming the hard coating layer may be the above-described hard-coating agent. For example, the hard-coating agent may be supplied by a slit nozzle and provided onto the base layer BL. The hard-coating agent may have a viscosity appropriate for being provided by the slit coating method. The hard coating layer HC may be formed from the hard-coating agent provided onto the base layer BL being dried and/or cured. The base layer BL with the hard coating layer HC being formed on the upper part thereof may be a preliminary protective film P-PL.

The anti-reflection layer ARL may be formed using a vacuum deposition polymerization device VC. That is, the anti-reflection layer ARL may be formed by a vacuum deposition polymerization method.

The vacuum deposition polymerization device VC may include a main body MB, a vacuum chamber EC, a pipe CO, a material supply part MS, and a support part SM. The vacuum chamber EC may be connected to the main body MB, and the pipe CO may be between the vacuum chamber EC and the material supply part MS. A material for forming the anti-reflection layer may be provided from the material supply part MS to the vacuum chamber EC through the pipe CO. The support part SM may be under the vacuum chamber EC to support the vacuum chamber EC. The support part SM may be provided in plurality, and its configuration, shape, etc. are not limited as long as it may support the vacuum chamber EC while bearing the load of the vacuum chamber EC. Meanwhile, the configuration of the vacuum deposition polymerization device VC illustrated in FIG. 8 is an example, and an embodiment is not limited thereto.

A first roller SR1 and a second roller SR2 may be inside the main body MB. The first roller SR1 may be spaced apart from the second roller SR2 in one direction. The first roller SR1 may be on an upper side, and the second roller SR2 may be on a lower side. In the one direction perpendicular to a plane, the first roller SR1 and the second roller SR2 may be arranged in a row, but the arrangement of the first roller SR1 and the second roller SR2 is not limited thereto. The first roller SR1 and the second roller SR2 may rotate in the forward direction of a process progressing direction PDR. For example, the first roller SR1 and the second roller SR2 may rotate clockwise.

A main roller MR may be between the first roller SR1 and the second roller SR2. The main roller MR may be in the vacuum chamber EC. The pipe CO may be adjacent to the main roller MR. The main roller MR may rotate in the opposite direction to the first roller SR1 and the second roller SR2. The main roller MR may rotate counterclockwise. A plurality of sub rollers TRa, TRb, TRc, TRd, TRe, TRf, and TRg may be between the first roller SR1 and the main roller MR, and between the second roller SR2 and the main roller MR. The sub rollers TRa, TRb, TRc, TRd, TRe, TRf, and TRg may be tension rollers.

In an embodiment, the anti-reflection layer ARL may be formed by providing the material for forming the anti-reflection layer onto the preliminary protective film P-PL. The preliminary protective film P-PL may be provided to the first roller SR1, and may be transferred by the sub rollers TRa, TRb, TRc, and TRd, and the main roller MR.

The material for forming the anti-reflection layer may be provided onto the preliminary protective film P-PL moving along the main roller MR. The material for forming the anti-reflection layer may be provided from the material supply part MS, and may be transferred through the pipe CO to the preliminary protective film P-PL positioned on the main roller MR.

The material supply part MS may include a first reactor CF1 and a second reactor CF2. The first reactor CF1 and the second reactor CF2 may accommodate different materials. The first reactor CF1 may accommodate a first material CM1, and the second reactor CF2 may accommodate a second material CM2. The first material CM1 and the second material CM2 may correspond to the materials for forming the anti-reflection layer, which may be different from each other.

The material supply part MS may further include a valve and a temperature controller. The valve may be connected to the first and second reactors CF1 and CF2 and the pipe CO to control supply of the materials accommodated in the first and second reactors CF1 and CF2. The temperature controller may be adjacent to each of the first reactor CF1 and the second reactor CF2 to create temperature conditions for the first reactor CF1 and the second reactor CF2, so that the first material CM1 and the second material CM2 may each be provided at a desired temperature.

The first material CM1 may include a fluorine-based silsesquioxane, and the second material CM2 may include an acrylate-based monomer. The first material CM1 may be provided in an amount of about 45 wt % or greater and about 60 wt % or less, and the second material CM2 may be provided in an amount of about 40 wt % or greater and about 55 wt % or less on the basis of the total weight 100 wt % of the first material CM1 and the second material CM2.

The protective film PL may be formed by a dry process. The first material CM1 and the second material CM2 may be provided at an ion acceleration voltage of about 100 V or greater and about 500 V or less. For example, the fluorine-based silsesquioxane and the acrylate-based monomer may be provided at an ion acceleration voltage of about 100 V or greater and about 500 V or less. When the ion acceleration voltage falls within the range of about 100 V or greater and about 300 V or less, adhesion and wear resistance of the anti-reflection layer ARL may be improved as the ion acceleration voltage increases. When the ion acceleration voltage falls within the range of about 300 V or greater and about 500 V or less, the anti-reflection layer ARL exhibiting improved adhesion and wear resistance may be formed regardless of the increase in ion acceleration voltage.

The anti-reflection layer ARL may be formed at about −30° C. to about 10° C. internal temperature of the vacuum chamber EC. For example, the anti-reflection layer ARL may be formed in a state where the temperature of the vacuum chamber EC is set to about −20° C. When the anti-reflection layer is formed at a temperature lower than about −30° C., molecular energy of the fluorine-based silsesquioxane and the acrylate-based monomer is low, so that the formation of the anti-reflection layer may not be easy. When the anti-reflection layer is formed at a temperature higher than about 10° C., the anti-reflection layer with low wear resistance may be formed. On the contrary, when the anti-reflection layer ARL is formed at a temperature of about −30° C. to about 10° C., the protective film PL according to an embodiment including the anti-reflection layer ARL may exhibit excellent reliability.

The anti-reflection layer ARL may be formed by deposition and polymerization of the fluorine-based silsesquioxane as the first material CM1 and the acrylate-based monomer as the second material CM2 on the preliminary protective film P-PL. In an embodiment, the first material CM1 and the second material CM2 may be provided onto the preliminary protective film P-PL moving along the main roller MR in the vacuum chamber EC to be deposited and polymerized. The first material CM1 and the second material CM2 may be polymerized while deposited on the preliminary protective film P-PL. From the first material CM1 and the second material CM2 deposited on the preliminary protective film P-PL, the silsesquioxane cage polymer according to an embodiment may be polymerized, and the anti-reflection layer ARL including the silsesquioxane cage polymer may be formed. The anti-reflection layer ARL, formed from the first material CM1 and the second material CM2, may have a thickness of about 95 nm or larger and about 105 nm or smaller. Since the anti-reflection layer ARL according to an embodiment is formed by deposition and polymerization of the first material CM1 and the second material CM2 on the preliminary protective film P-PL in the vacuum chamber EC, a nanoscale thin film may be manufactured in a uniform thickness. The protective film PL according to an embodiment may be manufactured from the anti-reflection layer ARL being formed on the preliminary protective film P-PL. The manufactured protective film PL may be transferred to the main body MB by the main roller MR, the sub rollers TRe, TRf, and TRg, and the second roller SR2.

A protective film according to an embodiment may include a base layer, a hard coating layer, and an anti-reflection layer stacked in sequence. The protective film may include a silsesquioxane cage polymer that is formed from components including a fluorine-based silsesquioxane and an acrylate-based monomer in the anti-reflection layer. Accordingly, the protective film according to an embodiment may exhibit anti-reflection characteristics, and at the same time, may provide excellent durability even though folding and unfolding operations are repeated at low curvature. Therefore, an electronic apparatus including the protective film according to an embodiment may not only have excellent folding reliability, but also provide images without color distortion, thereby exhibiting excellent display quality.

Since a protective film according to an embodiment includes an anti-reflection layer provided onto the uppermost part, and the anti-reflection layer includes a fluorine-based silsesquioxane cage polymer, the protective film may have an excellent effect in low-reflection characteristics and durability.

By including the above-described protective film, an electronic apparatus according to an embodiment may provide excellent low-reflection characteristics, and at the same time, may exhibit excellent folding reliability and display quality as damage such as cracks, etc. is suppressed during a folding operation at low curvature.

In the above, description has been made with reference to embodiments of the present disclosure, but those skilled or of ordinary skill in the art may understand that various modifications and changes may be made to the present disclosure insofar as such modifications and changes do not depart from the spirit and technical scope of the present disclosure set forth in the claims to be described later. Therefore, the technical scope of the present disclosure is not to be limited to the contents stated in the detailed description of the specification, but should be determined by the claims.

What is claimed is:

1. A protective film comprising:
a base layer;
a hard coating layer on the base layer; and
an anti-reflection layer on the hard coating layer,
wherein the anti-reflection layer comprises a silsesquioxane cage polymer, and
wherein the silsesquioxane cage polymer is formed from components comprising a fluorine-based silsesquioxane and an acrylate-based monomer.

2. The protective film of claim 1, wherein the fluorine-based silsesquioxane comprises at least one perfluoroalkyl group represented by Formula A below:
—CₙF₂ₙ₊₁ [Formula A]
wherein, in Formula A above,
n is an integer of 4 or greater and 30 or less.

3. The protective film of claim 2, wherein the at least one perfluoroalkyl group is connected to a silicon atom of the fluorine-based silsesquioxane via an ethylene group as a linker.

4. The protective film of claim 1, wherein the fluorine-based silsesquioxane is represented by Formula 1 below: 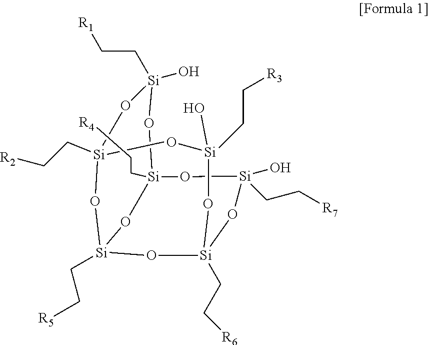
wherein, in Formula 1 above,
R₁ to R₇ are each independently —CₙF₂ₙ₊₁, and
n is an integer of 4 or greater and 30 or less.

5. The protective film of claim 1, wherein the fluorine-based silsesquioxane is represented by Formula 1-1 below:

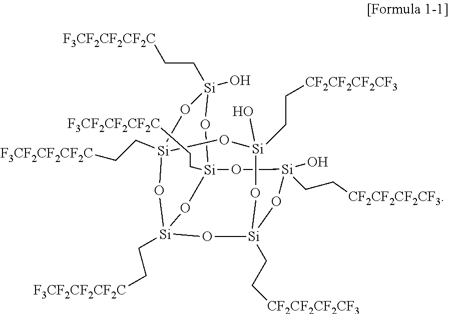

6. The protective film of claim 1, wherein the acrylate-based monomer comprises at least one of trimethylolpropane trimethacrylate or cyclohexyl methacrylate.

7. The protective film of claim 1, wherein the silsesquioxane cage polymer is formed from Formula 3 below: 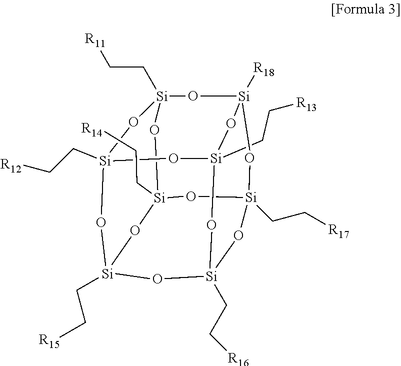
wherein, in Formula 3 above,
R₁₁ to R₁₇ are each independently —CₘF₂ₘ₊₁,
R₁₈ is represented by Formula B1 or Formula B2 below, and
n is 4 or greater and 30 or less:

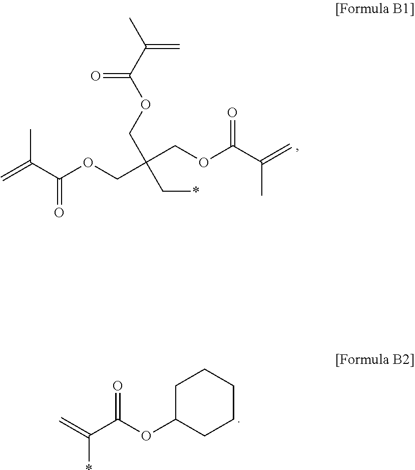

8. The protective film of claim 7, wherein R₁₁ to R₁₇ are —CF₂CF₂CF₂CF₃.

9. The protective film of claim 7, wherein R₁₁ to R₁₇ are all the same.

10. The protective film of claim 1, wherein the silsesquioxane cage polymer comprises at least one among compounds in Compound Group 1 below:

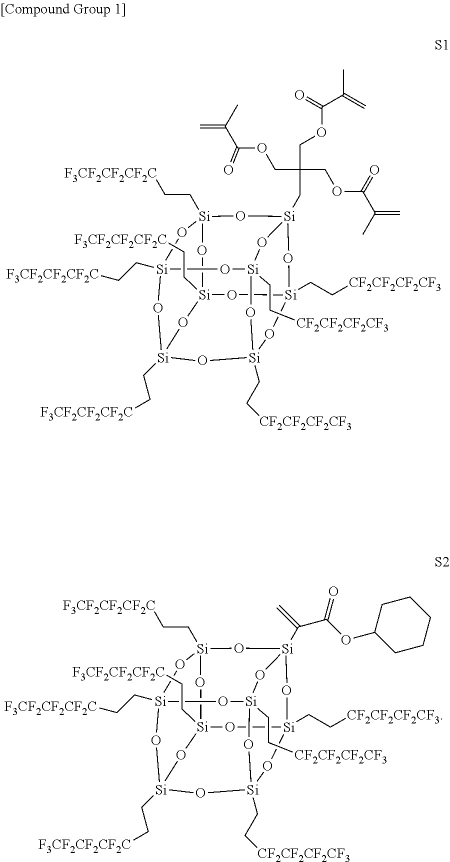

11. The protective film of claim 1, wherein the anti-reflection layer is a single layer.

12. The protective film of claim 1, wherein the anti-reflection layer has a specular component included (SCI) reflectance of about 1.5% or less for light with a wavelength of about 550 nm.

13. The protective film of claim 1, wherein the anti-reflection layer has a water contact angle of about 95° or greater.

14. The protective film of claim 1, wherein the anti-reflection layer has a thickness of about 95 nm or greater and about 105 nm or less.

15. The protective film of claim 1, wherein the silsesquioxane cage polymer is formed from components comprising, on a basis of a total 100 wt % of the fluorine-based silsesquioxane and the acrylate-based monomer:
the fluorine-based silsesquioxane in an amount of about 35 wt % or greater and about 60 wt % or less; and
the acrylate-based monomer in an amount of about 40 wt % or greater and about 65 wt % or less.

16. The protective film of claim 1, wherein the anti-reflection layer is formed by a vacuum deposition polymerization method.

17. An electronic apparatus comprising:
a display module in which at least one folding part and non-folding parts, spaced apart from each other with the at least one folding part therebetween, are defined along one direction; and
a window module on the display module, and comprising a window and a protective film stacked in sequence,
wherein the protective film comprises
a base layer;
a hard coating layer on the base layer; and
an anti-reflection layer on the hard coating layer,
wherein the anti-reflection layer comprises a silsesquioxane cage polymer, and
wherein the silsesquioxane cage polymer is formed from components comprising a fluorine-based silsesquioxane and an acrylate-based monomer.

18. The electronic apparatus of claim 17, wherein a first non-folding part, a first folding part, a second non-folding part, a second folding part, and a third non-folding part are defined along the one direction in the display module.

19. The electronic apparatus of claim 17, wherein the silsesquioxane cage polymer has a T₈ cage structure.

20. The electronic apparatus of claim 17, wherein the silsesquioxane cage polymer comprises 8 silicon atoms in a molecule, and
wherein a perfluoroalkyl group, represented by Formula A below, is connected to 7 silicon atoms among the 8 silicon atoms, and trimethylolpropane trimethacrylate or cyclohexyl methacrylate is connected to a remaining one silicon atom: 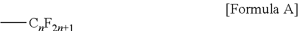
wherein, in Formula A above,
n is an integer of 4 or greater and 30 or less.
